(19) United States
(12) Patent Application Publication
(10) Pub. No.: US 2002/0188790 A1
(43) Pub. Date: Dec. 12, 2002

(54) Apparatus for converting 8-line/4-line ethernet into 2-line ethernet

(76) Inventors: Kyuho Park, Daejeon (KR); Hyunjun Choi, Suwon-si (KR); Chul Lee, Anyang-si (KR)

Correspondence Address: PENNIE & EDMONDS LLP, 1667 K STREET NW, SUITE 1000, WASHINGTON, DC, 20006

(21) Appl. No.: 10/067,415

(22) Filed: Feb. 7, 2002

(30) Foreign Application Priority Data
Apr. 11, 2001 (KR) 2001-19317
Jul. 6, 2001 (KR) 2001-40293

(51) Int. Cl. G06F 13/14

(52) U.S. Cl. 710/305

(57) ABSTRACT

The present invention relates to an apparatus for implementing high-speed data communications between a local area network (LAN) card and a switching hub through a pair of signal lines instead of a four-wire or an eight-wire transmission channel. The apparatus includes a first and a second conversion controller located between the LAN card and the switching hub and connected to the pair of signal lines. Each of the first and the second conversion controllers includes a first PHY and a second PHY, a Media Independent Interface Controller located between the first PHY and the second PHY for establishing a link mode, a data transmission speed, a duplex mode and an auto-negotiation (AN) state to be stored in the first and the second PHYs; and a conversion control logic located between the first PHY and the second PHY for transferring data and control signals with the first and the second PHYs to avoid the data collision occurred between the first and the second mediate devices through the pair of signal lines.

### FIELD OF THE INVENTION

The present invention relates to an Ethernet system; and, more particularly, to an apparatus for implementing high-speed data communications between a local area network (LAN) card and a switching hub through a two-wire transmission channel instead of a four-wire or an eight-wire transmission channel.

### BACKGROUND OF THE INVENTION

Referring to FIG. 1, there is illustrated a schematic block diagram of a typical Ethernet system configured pursuant to the IEEE 802.3 standard. The typical Ethernet system comprises at least one LAN card 10 installed in, e.g., a personal computer (PC), and a switching hub 20 and an unshielded twisted pair (UTP) cable 30. The LAN card 10 is connected to the switching hub 20 through the UTP cable 30 consisting of 4 or 8 physical signal lines or wires. Typically, among the 8 signal lines, the 1^{st}, 2^{nd}, 3^{rd} and 6^{th} signal lines are used as two output lines TX+ and TX− and two input lines RX+ and RX−, respectively, to transmit or receive Ethernet data and the remaining 4 signal lines are used for voltage references of the signals. Meanwhile, the Ethernet system employing the 4-wire transmission channels uses only 4 signal lines of the UTP cable.

Prior to normal data exchange, the LAN card 10 and the switching hub 20 exchange a Normal Link Pulse (NLP) signal through the 1^{st}, 2^{nd}, 3^{rd} and 6^{th} signal lines of the UTP cable 30, in order to perform a link status check. Through the link status check, it is checked whether or not each link partner is connected to each other and in normal operation mode. Herein, the LAN card 10 is regarded as a link partner of the switching hub 20, and vice versa. If the result of the link status check is found to be normal, the Ethernet system becomes activated to be ready for exchanging Ethernet data between the link partners. Then, the LAN card 10 and the switching hub 20 cooperate to perform a so-called Auto-Negotiation (AN) through the 1^{st}, 2^{nd}, 3^{rd} and 6^{th} signal lines of the UTP cable 30 to determine an optimal data rate, e.g., 10 Mbps or 100 Mbps, to select a duplex mode, e.g., a half duplex mode or a full duplex mode, or the like.

In the meantime, due to increasing demand for high-speed data communications, e.g., of several Mbps, there have been sought various ways to provide such high-speed data communication for not only newly-constructed buildings but also already-established buildings such as apartment houses, office buildings, hotels, and the like. As one of such ways, leased lines can be a good solution. The leased lines, however, bears some drawbacks: the number of supply thereof is limited; the installation thereof is not sometimes available; and, above all, it exacts high cost. As a counter measure, there has been proposed an approach of employing an ordinary telephone wire so as to implement the high-speed data communications. There are popular ways to implement the high-speed data communication by using the ordinary telephone lines: one is an asymmetric digital subscriber line (ADSL) system; and the other is the Ethernet system using 4 signal lines. The ADSL system uses a DSL modem and the Ethernet system employs a LAN card and a switching hub. FIG. 1 illustrates a typical Ethernet system.

Although the two systems are dozens of times faster than conventional modems typically having 56 Kbps, the two systems have respective merits and demerits. Among others, the DSL modem is far more expensive than the Ethernet system.

Accordingly, if the Ethernet system with two signal lines is available, the high-speed data communications can be readily available even at home.

### SUMMARY OF THE INVENTION

It is, therefore, an object of the present invention to provide an apparatus capable of performing high-speed data communications in an Ethernet environment by using a 2-wire transmission channel without deteriorating its performance.

In accordance with a preferred embodiment of the present invention, there is provided an Ethernet system for performing data communications between a LAN card and a switching hub, each of which has a Physical Layer Interface (PHY) and has the relationship of link partners, which comprises:

a first and a second conversion controllers located between the LAN card and the switching hub for intermediating the data communications with their respective corresponding link partners; and

a pair of signal lines for connecting the first and the second conversion controllers,

wherein the first and the second conversion controllers are regarded as sub-link partners of their respective corresponding link partner, and each of the first and the second conversion controller includes:

a first PHY and a second PHY, wherein the first PHY is connected to its corresponding link partner through an unshielded twisted pair (UTP) cable and the second PHYs contains two output terminals TX+ and TX− and two input terminals RX+ and RX−, for interfacing with its sub-link partner, wherein the output terminal TX+ and the input terminal RX+ are tied to one of the signal lines and the output terminal TX− and the input terminal RX− are connected to the other of the signal lines, and wherein each of the first and the second PHYs has a basic register and auxiliary register for storing particular values;

a Media Independent Interface Controller(MIIC) located between the first PHY and the second PHY for establishing a link mode, a data transmission speed, a duplex mode and an auto-negotiation (AN) state to be stored in the first and the second PHYs; and

a conversion control logic located between the first PHY and the second PHY for preventing the data transmitted from one of the second PHYs to the other second PHY from being looped back to the one of the second PHY.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram of a typical Ethernet system;

FIG. 2 illustrates a block diagram of an Ethernet system in accordance with the present invention;

FIG. 3 describes a detailed block diagram of an Ethernet system as shown in FIG. 2;

FIG. 4A and 4B show configurations of basic registers and auxiliary registers in a PHY, respectively;

FIGS. 5A to 5C depict timing diagrams of signals generated in an operation of the Ethernet system in accordance with the present invention;

FIGS. 6A and 6B provide a detailed block diagram of a MIIC as shown in FIG. 3 and a sequential diagram explaining an operation thereof, respectively;

FIGS. 7A and 7B show a detailed block diagram of a conversion control logic as shown in FIG. 3 and a sequential diagram explaining an operation thereof, respectively; and

FIG. 8 illustrates another embodiment of either first or second conversion control logic as shown in FIG. 7.

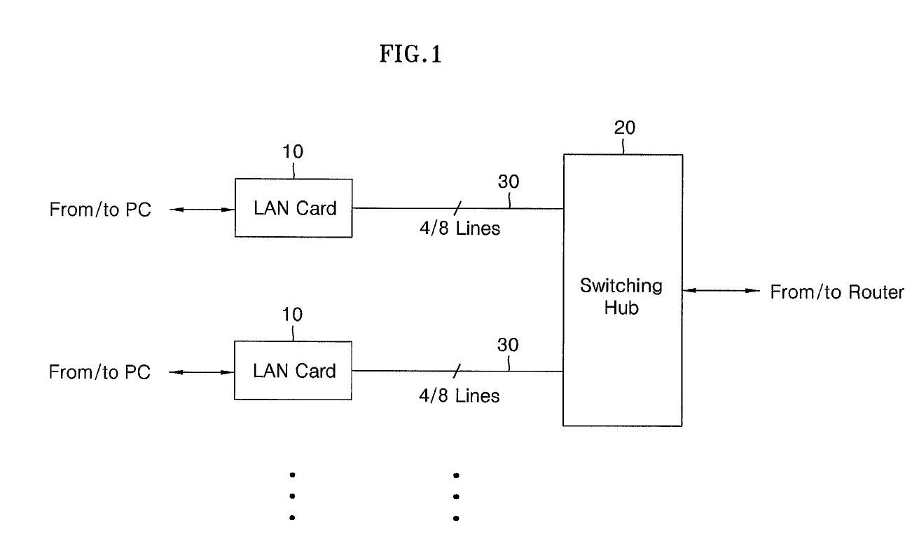

### DETAILED DESCRIPTION OF THE PREFERRED EMBODIMENTS

The present invention is to provide an apparatus capable of performing high-speed data communications in an Ethernet environment by using a 2-wire transmission channel, rather than 4-wire or 8-wire transmission channel.

The preferred embodiments of the present invention will now be described in detail in parallel with the attached drawings.

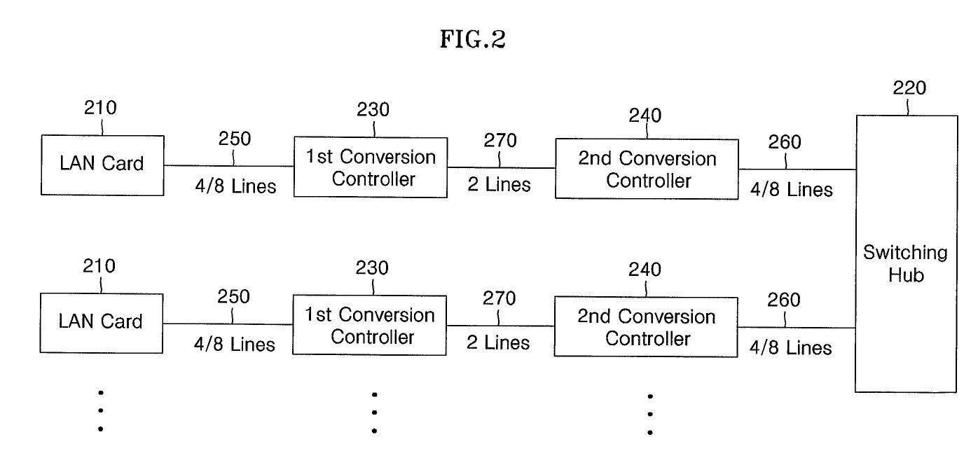

Referring to FIG. 2, there is shown a block diagram of an Ethernet system in accordance with a preferred embodiment of the present invention.

The inventive Ethernet system comprises at least one LAN card 210, a switching hub 220, a set of a first and a second conversion controller 230 and 240, 4/8-wire UTP cables 250 and 260 and a pair of 2-wire signal lines of either UTP cable or telephone lines 270. The LAN card 210 is connected to the first conversion controller 230, the first conversion controller 230 is connected to the second conversion controller 240 and the second conversion controller 240 is connected to the switching hub 220. The 4/8-wire UTP cable 250 connects the LAN card 210 to the first conversion controller 230, while the 4/8-wire UTP cable 260 connects the second conversion controller 240 to the switching hub 220. On the contrary, the pair of 2-wire signal lines of either UTP cable or telephone lines 270 connects the first conversion controller 230 to the second conversion controller 240. For the purpose of illustration, it is assumed that the LAN card 210 is a link partner of the switching hub 220, and vice versa; and further, each of the first and the second conversion controllers 230 and 240 has also a relationship of sub-link partner of its corresponding link partner.

In FIG. 2, although there are shown simply two LAN cards 210 involved for data communications with the switching hub 220 for the simplicity of explanation, it would be easily understood that the switching hub 220 has multiple ports capable of accommodating a plurality of LAN cards.

The LAN card 210 is, e.g., a typical network interface The LAN card 210 is, e.g., a typical network interface card embedded in a personal computer, and basically includes therein a physical layer interface (PHY) (not shown) The LAN card 210 also includes therein a media access controller (MAC) (not shown) for implementing a control of physical layer interface pursuant to the specifications of, e.g., IEEE 802.3 standard.

Meanwhile, the switching hub 220 receives Ethernet packets from either the LAN card 210 or external routers (not shown), and on the other hand, distributes the received Ethernet packets to the LAN card 210 or the external routers. For the exchange of the Ethernet packets, the switching hub 220 employs a physical layer interface (PHY)(not shown) and a switching controller (not shown) for use in the physical layer interface.

A detailed description of the PHY, the MAC and the switching controller is illustrated in U.S. Ser. No. 09/969,259, entitled “TWO-WIRE ETHERNET SYSTEM FOR DIGITAL SUBSCRIBER LINE COMMUNICATIONS”, filed on Oct. 1, 2001 by Kyu-Ho Park and Hyun-Jin Choi, which is incorporated herein by reference.

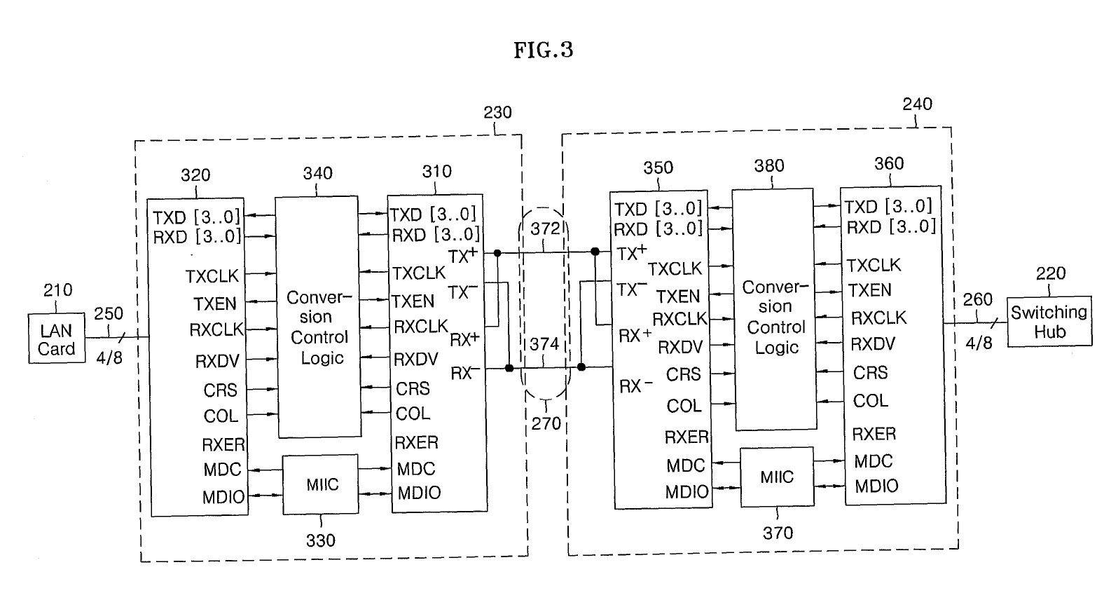

Referring now to FIG. 3, there is shown a detailed block diagram of the first and the second conversion controllers 230 and 240 as shown in FIG. 2.

As shown, each of the first and the second conversion controllers 230 and 240 includes a pair of first and second of the first and the second PHYs perform substantially identical functions to that of the PHY in the LAN card 210 and uses a media independent interface (MII), which follows the specifications of, e.g., IEEE 802.3 standard.

The first PHYs 310 and 350 in the first and the second conversion controllers 230 and 240, respectively, are connected to each other by the pair of a first and a second signal lines 372 and 374 of the 2-wire UTP cable or 2-wire telephone lines 270 through which data communications between the link partners 210 and 220 are performed. In the connection, an output terminal TX+ and an input terminal RX+ of each first PHY 310 or 350 are combined to be connected to the first signal line 372, while an output terminal TX− and an input terminal RX− of each first PHY 310 and 350 are combined to be connected to the second signal line 374. Meanwhile, the second PHYs 320 and 360 are connected to their corresponding link partners, i.e., the LAN card 210 and the switching hub 220 through the 4/8-wire UTP cables 250 and 260, respectively.

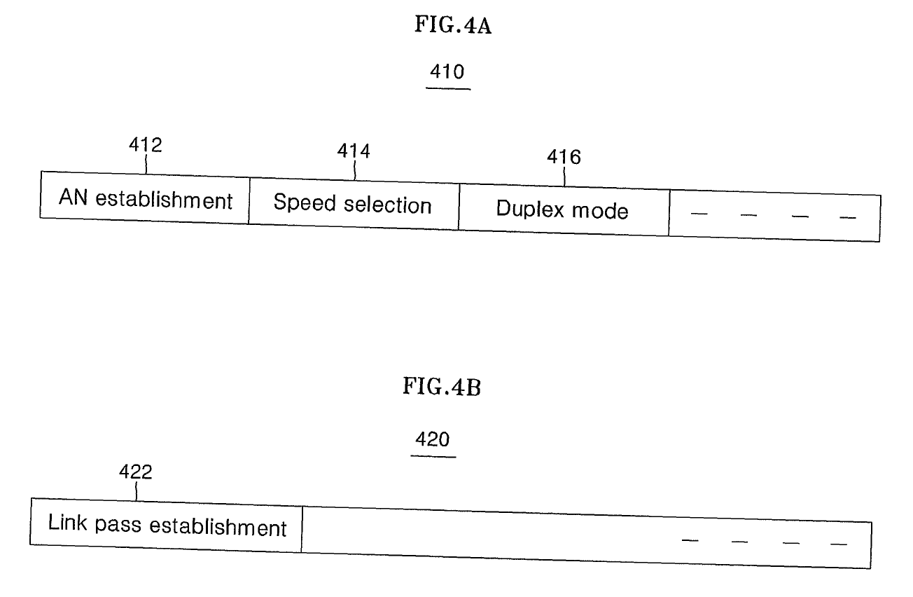

Further, each of the first and the second PHYs 310, 320; and 350, 360 in the conversion controllers 230 and 240 contains a basic register 410 and an auxiliary register 420 as detailed in FIGS. 4A and 4B, which follow the IEEE 802. 3 standard.

Referring to FIGS. 4A and 4B, the basic register 410 includes an auto-negotiation (AN) establishment sector 412 for storing a value determining whether or not to perform an auto-negotiation process between the link partners, a speed selection sector 414 for selecting a specific data transmission speed and a duplex mode sector 416 which stores specific values used in setting a duplex mode when the Ethernet packets are transmitted between the link partners 210 and 220. The values stored in the sectors 412, 414 and 416 are initialized with predetermined default values.

In the meantime, the auxiliary register 420 includes a link pass establishment sector 422 for storing a specific value used for determining whether or not to examine normal link pulse (NLP) signals transmitted between the link partners 210 and 220. The value stored in the link pass establishment sector 422 is initialized with a default value.

Referring back to FIG. 3, each of the first and the second conversion controllers 230 and 240 further comprises a Media Independent Interface Controller (MIIC) 330 and 370, respectively, located in-between the PHYs 310 and 320; and 350 and 360, for setting the registers 410 and 420 with specific values, and a conversion control logic 340 and 380 for controlling a data transfer and negotiating a data collision occurred between the sub-link partners 230 and 240 and thus the link partners 210 and 220 through the pair of signal lines 372 and 374, respectively.

In accordance with the present invention, since the LAN card 210 and the switching hub 220 are connected to each other through the first and the second conversion controllers 230 and 240 which are then connected to each other via the only two wires 372 and 374, data communications between the LAN card 210 and the switching hub 220 may be obstructed without a proper interface controller. In light of this, each of the MIIC 330 and 370 performs a series of process for setting the registers 410 and 420 in the first and the second PHYs 310 and 320; and 350 and 360 with specific values, in order to transfer the Ethernet packets between the LAN card 210 and the switching hub 220 through the pair of wires 372 and 374.

The operations of the MIICs 330 and 370 will now be explained in detail. Since the configurations of the first and the second conversion controllers 230 and 240 are substantially identical to each other, for the simplicity of explanation, only the operation of the MIIC 330 of the first conversion controller 230 will be described hereinafter.

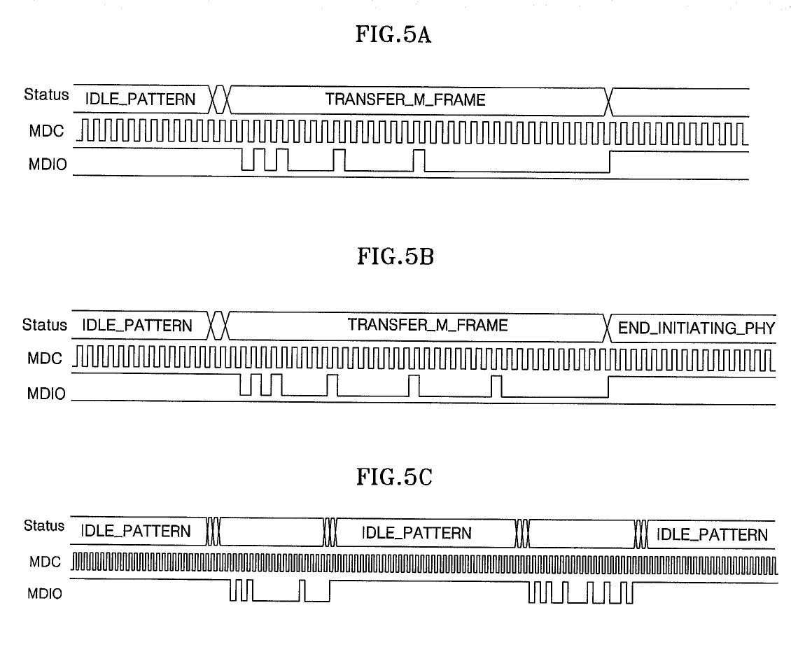

In accordance with the present invention, the MIIC 330 provides the second PHY 320 with signals, e.g., MDC and MDIO signals as described in FIG. 5A, for setting the AN establishment sector 412 to define “an AN activation state,” setting the speed selection sector 414 to define “10 Mbps or 100 Mbps” and setting the duplex mode sector 416 to define “a half duplex mode” by way of a Management Data Clock (MDC) terminal and a Management Data Input/Output (MDIO) terminal as described in FIG. 3. In this connection, in a full duplex mode, the data transfer between the sub-link partners 230 and 240 can be bidirectionally and simultaneously made, whereas in the half duplex mode, the data transfers are alternatively carried out.

Then, states of the data transmission speed and the duplex mode set at the basic register 410 are reported by using the AN process to the PHY in the LAN card (not shown) 210 and the PHY in the switching hub 220 (not shown) to have the same values as set in the basic register 410.

Therefore, since the duplex mode of the second PHY 320 is set as the half duplex mode, it is guaranteed that the LAN card 210 cannot transmit Ethernet packets while the LAN card 210 receives Ethernet packets through the UTP cable 250, thereby preventing the data collision from occurring between the sub-link partners 230 and 240.

On the other hand, the first PHY 310 of the conversion controller 230 exchanges NLP signals with the first PHY 350 of the conversion controller 240 so as to execute a link status examination process through which it is checked out whether or not the first PHY 350 is connected thereto and normally operates.

Since, however, the input terminal RX+ (or RX−) and the output terminal TX+ (or TX−) of the conversion controllers 230 and 240 are tied to each other through one signal line 372 (or 374) as shown in FIG. 3, and thus the first PHY 310 receives back an NLP signal outputted therefrom as well as an NLP signal from the first PHY 350 and could confusedly recognize it as an NLP signal transmitted from the first PHY 350 of the conversion controller 240, it is impossible for the PHY 310 to successfully execute the link status examination process only by checking out the NLP signal inputted thereto through its input terminal RX+ (or RX−).

Likewise, as mentioned above, since the input/output terminals RX+ and TX+ (or RX− and TX−) of the first PHYs 310 and 350 are connected to each other through the signal line 372 (or 374), the first PHY 310 of the first conversion controller 230 may receive back an AN signal outputted therefrom and could recognize mistake it as an AN signal transmitted from the first PHY 350 of the second conversion controller 240. Therefore, it is inappropriate to determine a maximum data transmission speed and the duplex mode between the sub-link partners 230 and 240 by using the result of the AN process.

Therefore, in accordance with the present invention, the MIIC 330 provides the first PHY 310 with signals, i.e., the MCD and the MDIO signals as described in FIG. 5B, for the purpose of setting the link pass establishment sector 422 to always have a value representing a “link pass” state through the MDC terminal and the MDIO terminal of the first PHY 310. As a result, the first PHY 310 in the first conversion controller 230 can determine that its counterpart, i.e., the first PHY 350 in the second conversion controller 240, is always connected thereto and normally operates without examining the NLP signal transmitted from the first PHY 350 in the second conversion controller 240. Therefore, it is assured that the link between the sub-link partners 230 and 240 is always activated regardless of whether or not the sub-link partners 230 and 240 are connected to each other and normally operate.

Moreover, in accordance with the present invention, the MIIC 330 provides the first PHY 310 with signals, i.e., the MCD and the MDIO signals as shown in FIG. 5C, for setting the AN establishment sector 412 to define “an AN inactivation state,” the speed selection sector 414 to define “10 Mbps or 100 Mbps” and the duplex mode determination sector 416 to define “a full duplex mode” through the MDC terminal and the MDIO terminal of the first PHY 310.

Therefore, the Ethernet packet from the LAN card 210 can be transferred to the first conversion controller 230 through the UTP cable 250, and subsequently to the second conversion controller 240 through the signal line 372, and then finally to the switching hub 220 through the UTP cable 260. Likewise, the Ethernet packets from the switching hub 220 can be transferred through the reverse path as described above, i.e., the UTP cable 260, the second conversion controller 240, the signal line 374, the first conversion controller 230, the UTP cable 250 and then the LAN card 210.

As described above, major role of the MIIC 330 (or 370) lying between the first and the second PHYs 310 and 320 (or 350 and 360) is to set the registers 410 and 420. As a result, MIIC 330 (or 370) enables the present invention to accomplish data communications between the link partners 210 and 220 and thus the sub-link partners 230 and 240 by using the pair of signal lines 372 and 374.

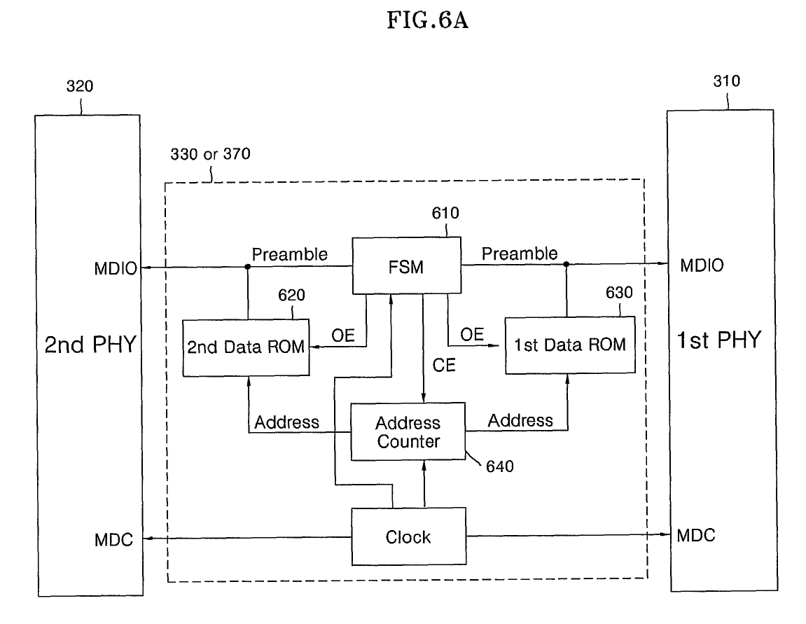

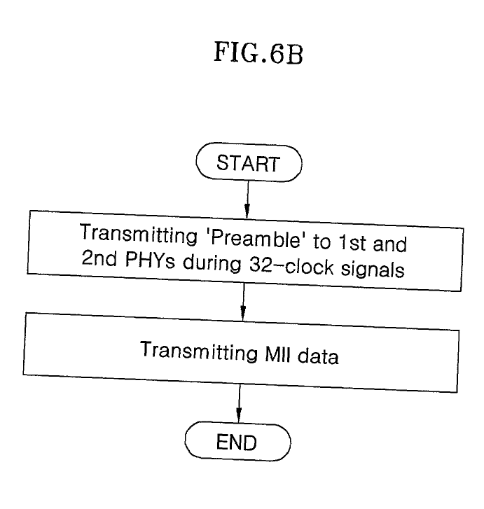

As shown in FIG. 6A, the MIIC 330 (or 370) includes a FSM(Finite State Machine) 610 for performing a control procedure as shown in FIG. 6B, a first and a second data ROMs 620 and 630 storing data on specific values for establishing the registers 410 and 420 in the PHYs 310 and 320 (or 350 and 360) and an address counter 640. As described in FIG. 6B, at an initial state, the MIIC 330 provides a preamble signal having a logic high state or ‘1’ for 32 clocks to the MDIO terminal in each of the first and the second PHYs 310 and 320. And then, the MIIC 330 provides a CE(Counter Enable) signal and an OE(Output Enable) signal for enabling the address counter 640 and the first and the second data ROMs 620 and 630, respectively. In response to the CE signal, the address counter 640 begins to generate an address signal to the first and the second data ROMs 620 and 630, so that the specific values stored in the first and the second data ROMs 620 and 630 are transferred to the registers 410 and 420 in the PHYs 310 and 320. Then, the transferred number of bits are checked. When the data transfer is completed, all outputs through the MDIO terminal are removed. By doing this, the registers 410 and 420 in the PHYs 310 and 320 are initialized.

On the other hand, referring back to FIG. 3, the conversion controller 230 (or 240) further comprises a conversion control logic 340 (or 380), which is located between the first and second PHYs 310 and 320 (or 350 and 360) to provide a mechanism for preventing data collision.

Since the configuration and the operation of the conversion control logic 340 of the first conversion controller 230 is substantially identical to the conversion control logic 380 of the second conversion controller 240, and, therefore, only one, e.g., the conversion control logic 340 will be described for the purpose of illustration.

First of all, as mentioned above, since the first PHY 310 and 350 in the first and the second conversion controllers 230 and 240 are set to operate in the full duplex mode by its corresponding MIIC 330 and 370, respectively, it is possible for each of the first PHYs 310 and 350 to simultaneously transfer Ethernet packets to each other. That is, the PHY 310 is allowed to transmit Ethernet packets to its sub-link partner 350 even while it is receiving Ethernet packets from its sub-link partner 350, and vice versa. In the prior art using two pairs of signal lines, no data collision occurs during the data transmission since input lines and output lines are separated. However, in the present invention using one pair of signal lines 372 and 374 in which the input terminal and the output terminal are soldered to each other, since the data being transmitted and the data being received may collide on the same signal line, the collision may ruin the data being transferred.

In addition to the collision problem, a so-called loop-back phenomenon may be involved between the first and the second conversion controller 230 and 240 serving the mediation between the LAN card 210 and the switching hub 220 since their input and output terminals are connected to each other through the pair of signal lines 372 and 374. That is, due to the loop-back phenomenon, the first conversion controller 230 or the second conversion controller 240 may receive back Ethernet packets transmitted therefrom during its data transmission to its sub-link partner. As a result, the LAN card 210 or the switching hub 220 mistakes the Ethernet packets transmitted therefrom to its link partner for Ethernet packets transmitted from its link partner.

Therefore, as described above, in order to prevent the data collision, the MIIC 330 sets the second PHY 320 as the half duplex mode, thereby avoiding the data collision between the sub-link partners.

Secondly, in order to preclude the loop-back phenomenon, the conversion control logic 340 eliminates the Ethernet packets looped back to the second PHY 320 through an input terminal RX+ during the data transmission of the first PHY 310. This loop-back prevention is achieved by using a characteristic of the receive data valid signal RXDV that maintains a logic high state ‘1’ during the data transmission from the PHY 310 to the PHY 350, wherein the conversion control logic 340 intercepts the receive data valid signal RXDV in order not for the second PHY 320 to receive the looped back Ethernet packets, thereby preventing the second PHY 320 from receiving the Ethernet packets looped back provided from the first PHY 310.

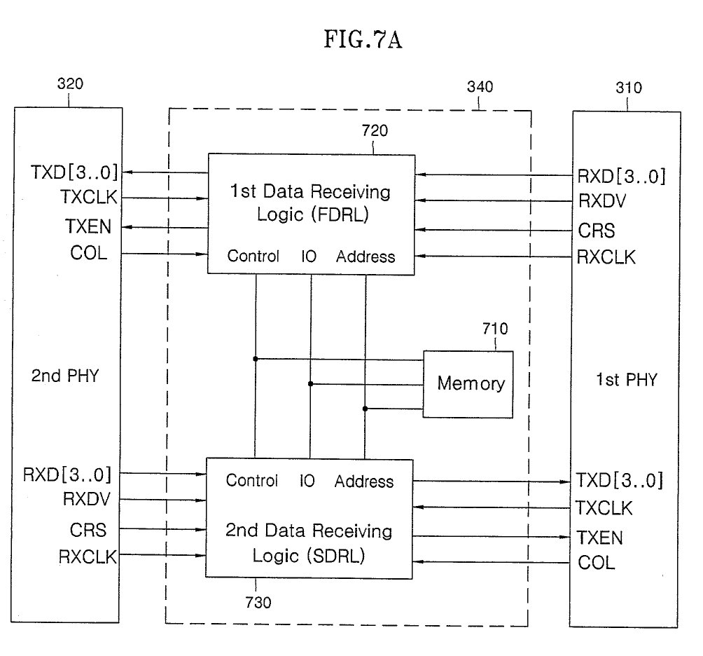

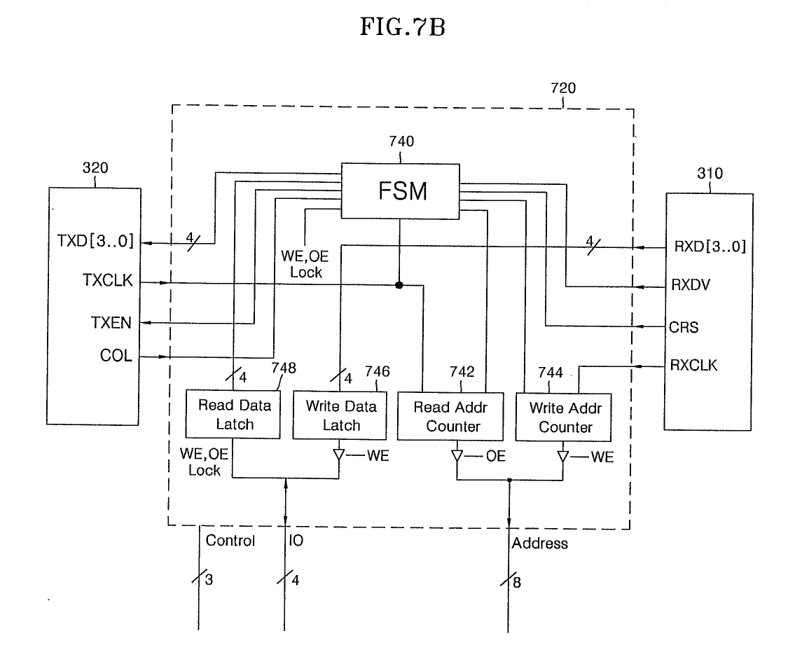

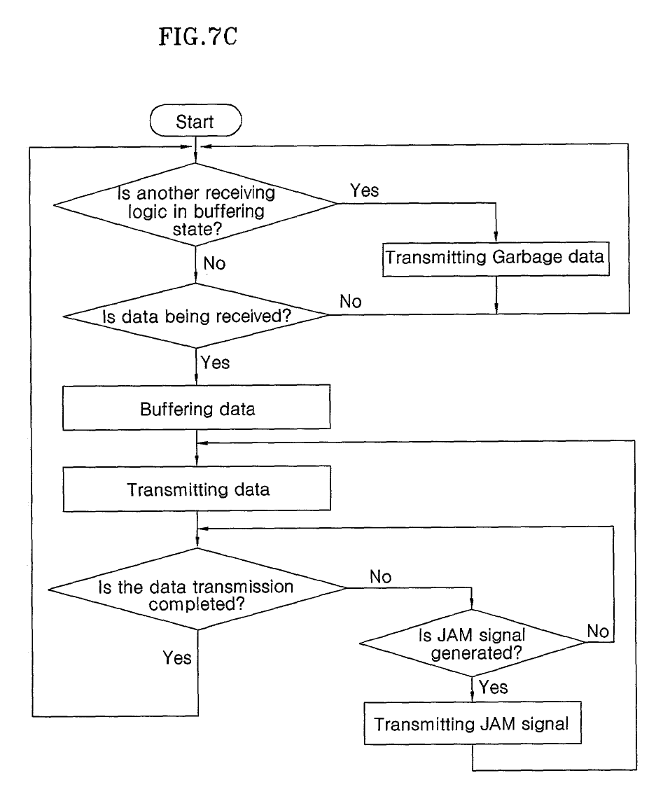

The conversion control logic 340 (or 380) will be described in detail with reference to FIG. 7A and 7B. As shown in FIG. 7A, the conversion control logic 340 (or 380) includes a memory 710, a first data receiving logic(FDRL) 720 and a second data receiving logic(SDRL) 730. The memory 710 is used for buffering received Ethernet packets before transmitting the Ethernet packets. The Ethernet packets buffered in the memory 710 are transmitted when the data collision occurs, thereby preventing the loss of the Ethernet packets. More specifically, when the FDRL 720 receives Ethernet packets from the first PHY 310 while the SDRL 730 tries to transmit Ethernet packets to the first PHY 310, the first PHY 310 perceives the data collision and generates a “COL” signal notifying the data collision. Since the Ethernet packets stored in the memory 710 is lost by the data collision during transmitting Ethernet packets to the second PHY 320, the SDRL 730 delays the transmission of the Ethernet packets and re-transmits the Ethernet packets stored in the memory 710 after some delay, thereby minimizing the loss of the Ethernet packets by the collision. Further, each of the FDRL 720 and the SDRL 730 provides both of the received Ethernet packets along with a “Preamble” signal to its corresponding first and second PHYs 310 and 320 in order to recover the Preamble signal to its original length.

The FDRL 720 receives Ethernet packets from the first PHY 310 and then transmits the received Ethernet packets to the second PHY 320, while the SDRL 730 receives the Ethernet packets from the second PHY 320 and transmits the received Ethernet packets to the first PHY 310. The operations performed by the FDRL 720 and the SDRL 730 are substantially identical to each other, and therefore, the following description will be made only for the operation of the FDRL 720 in parallel with FIG. 7C.

In an initial state made by resetting the FDRL 720, it is determined whether or not the SDRL 730 is now in a buffering state. If it determined that the SDRL 730 is in the buffering state, the FDRL 720 transmits garbage data to its corresponding second PHY 320 to prevent the LAN card 210 from transmitting Ethernet packet therefrom. However, if the SDRL 730 is not in the buffering state, it is checked that the FDRL 720 is now receiving the Ethernet packets from the first PHY 310. When the FDRL 720 receives the Ethernet packets from the first PHY 310, the FDRL 720 initiates the data buffering by storing the received Ethernet packets into the memory 710. If the data buffering is completed, the FDRL 720 begins to transmit the Ethernet packets buffered in the memory 710 to the second PHY 320. If there occurs the data collision during the data transmission, the FDRL 720 generates a JAM signal and tries to re-transmit the Ethernet packets. If the data re-transmission is successively completed, the FDRL 720 returns to the initial state waiting for the Ethernet packets from the first PHY 310.

Each of the FDRL 720 and the SDRL 730 has a substantially identical configuration with each other, and therefore, the following description will be made only for the FDRL 720 with reference to FIG. 7B.

The FDRL 720 includes a FSM 740, a Read Address Counter 742 for interfacing between the FSM 740 and the memory 710 (see, FIG. 7A) and for addressing the memory 710 in a memory READ mode, a Write Address Counter 744 for addressing the memory 710 in a memory WRITE mode, a Write Data Latch 746 for temporarily storing the Ethernet packets received from the ports RXD[3 . . . 0] of the first PHY 310 before being stored in the memory 710, a Read Data Latch 748 for temporarily storing the Ethernet packets to be transmitted to the ports TXD[3 . . . 0] of the second PHY 320, wherein the SE signal is used for activating a reading operation of the memory 710, a WE signal is used for enabling the writing operation of the memory 710, and a Lock signal is used for inhibiting the buffering operation of the SDRL 730 while the FDRL 720 performs the data buffering and the data transmission.

In Table 1, there are shown comparison results of the performance of the preferred embodiment of the present invention and that of the prior art using two pairs of signal lines, when 160 Mbytes data is transmitted by using the FTP (File Transfer Protocol) under a condition in which the data transmission speed is 10 Mbps and the duplex mode is the full duplex mode.

TABLE 1
FTP Transmission Size: 160 Mbytes

| Present Invention | | | |
|---|---|---|---|
| Employing MIIC and | | | |
| Conversion Control Logic | | Prior Art | |
| Data | | Data | |
| Transmission | | Transmission | |
| Time | Throughput | Time | Throughput |

| | | | |
|---|---|---|---|
| 16.1 sec | 8.36 Mbps | 14.2 sec | 9.45 Mbps |

As can be seen from Table 1, in the Ethernet system employing both of the MIIC and the conversion control logic, the data communications using one pair of signal lines has the performance substantially similar to that of the prior art.

In the present invention, each of the first and the second conversion controllers 230 and 240 includes a pair of the first and second PHYs 310 and 320; 350 and 360, the MIIC 330; 360 and the conversion control logic 340; 380 respectively, which follow the specification of, e.g., IEEE 802.3 standard, respectively. Each of the first and the second conversion controllers 230 and 240 enables the data communications between the LAN card 210 and the switching hub 220 in the half duplex mode in the condition that the first and the second conversion controllers 230 and 240 communicate by using a pair of signal lines 372 and 374.

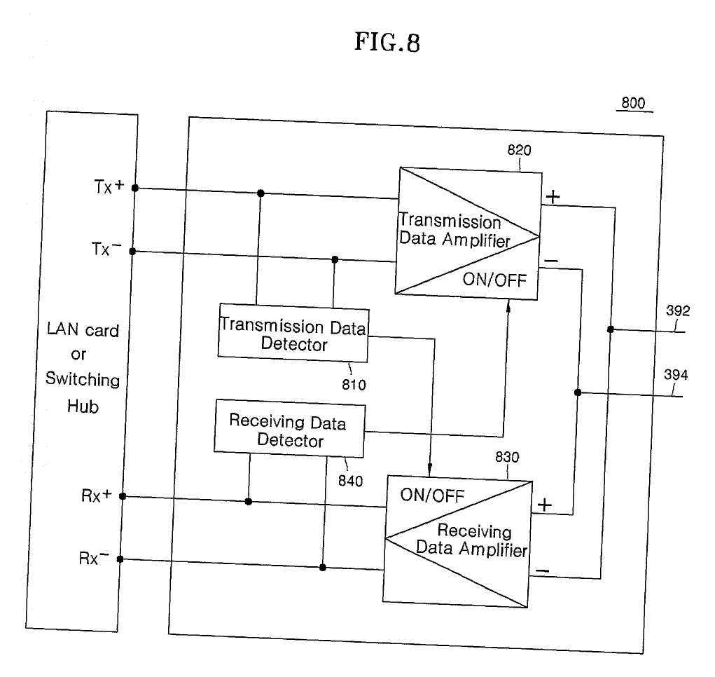

FIG. 8 illustrates an analog type of conversion controller 800, which can replace either the conversion controller 230 or 240 as shown in FIG. 3.

The analog conversion controller 800 includes a transmission data detector 810 for detecting the transmission data transmitted from the LAN card 210 or the switching hub 220, a transmission data amplifier 820 for amplifying the transmission data, a receiving data amplifier 830 for amplifying the receiving data received from the switching hub 220 or the LAN card 210, and a receiving data detector 840 for detecting the output of the receiving amplifier 830. During the data transmission from any one of link partners to its link partner, the transmission data detector 810 detects the transmission data and produces a logic state ‘High’ to set the receiving data amplifier 830 in an OFF state. Conversely, during the data receiving from any one of link partners to its link partner, the receiving data detector 840 detects the receiving data to produces a logic state ‘High’ to set the transmission data amplifier 820 in an OFF state. In case where each of the data detectors 810 and 840 produces a logic state ‘Low’, each of its corresponding amplifiers 830 and 820 normally performs its amplifying operation. The analog conversion controller 800 performs a similar operation to that of the first or the second conversion controller 230 or 240 except that it is not provided with the same memory 710 as shown in FIG. 7A for the data buffering. When one of the conversion controllers 230 and 240 is replaced with the analog conversion controller 800, the buffering operation is performed by remaining one of the conversion controllers 230 and 240.

In the meantime, each set of the PHYs 310 and 320; 350 and 360, respectively, can be operated based on different frequencies. Without the inventive Ethernet system, for instance, the data communication between the LAN card 210 and the first conversion controller 230 is served at 10 MHz, the data communication between the first conversion controller 230 and the second conversion controller 240 is served at 2.5 MHz and the data communication between the second conversion controller 240 and the switching hub 220 is served at 10 MHz. In these cases, normally, there occurs an error between the first and second PHYs operated based on different frequencies.

In the inventive Ethernet system, however, concept of the data buffering as mentioned above is applied so that the conversion control logic 340 or 380 in the first or second conversion controller 230 or 240 temporarily stores a certain amount of data in the memory (not shown) before being transmitted to its sub-link partner, thereby enabling the data communication between the LAN card 210 and the switching hub 220 without error. For example, if it is assumed that the data served in 10 MHz is transmitted from the LAN card 210 to the first conversion controller 230 while the data served in 2.5 MHz is transmitted from the first conversion controller 230 to the second conversion controller 240 through a pair of signal lines, the conversion control logic 340 in the first conversion controller 230 temporally stores the data served at 10 MHz in the memory and then readouts the data at 2.5 MHz to provide it to the second conversion controller 240. Therefore, although the frequency for the data communication between the first conversion controller 230 and the second conversion controller 240 is lower than that of the data communication between the LAN card 210 and the first conversion controller 230 and between the second conversion controller 240 and the switching hub 220, it is possible to perform the data communication between the LAN card 210 and the switching hub 220. The main reason for lowering the frequency between the first conversion controller 230 and the second conversion controller 240 is to lengthen the distance between the LAN card 210 and the switching hub 220.

Practically, however, when the two PHYs 310 and 320; 350 and 360, respectively, are operated at different base frequencies, complete prevention of the data collision may not be guaranteed.

For example, while the data at 2.5 MHz received from the second PHY 320 is being stored into the memory, the LAN card 210 may try to transmit data at 10 MHz to its link partner 220 since UTP cable 250 is not being used, which may cause the data collision.

In order to overcome this data collision, during the second PHY 320 is receiving the data, the conversion control logic 340 issues to the first PHY 310 a command delaying the data transmission, to thereby avoid the data collision.

While the present invention has been described with respect to the particular embodiments, it will be apparent to those skilled in the art that various changes and modifications may be made without departing from the spirit and scope of the invention as defined in the following claims.

What is claimed is:

1. An Ethernet system for performing data communications between a LAN card and a switching hub, each of which has a Physical Layer Interface (PHY) and has the relationship of link partners, which comprises:
a first and a second conversion controllers located between the LAN card and the switching hub for intermediating the data communications with their respective corresponding link partners; and
a pair of signal lines for connecting the first and the second conversion controllers;
wherein the first and the second conversion controllers are regarded as sub-link partners of their respective corresponding link partners of the LAN card and the switching hub to perform the data communication between the link partners through the pair of signal lines, respectively, and each of the first and the second conversion controller includes:
a first PHY and a second PHY, wherein the first PHY is connected to its corresponding link partner via an unshielded twisted pair (UTP) cable and the second PHYs contains two output terminals TX+ and TX− and two input terminals RX+ and RX−, wherein the output terminal TX+ and the input terminal RX+ are attached to one of the signal lines and the output terminal TX− and the input terminal RX− are connected to the other of the signal lines;
a Media Independent Interface Controller(MIIC) located between the first PHY and the second PHY for establishing a link mode, a data transmission speed, a duplex mode and an auto-negotiation (AN) state to be stored in the first and the second PHYs; and
a conversion control logic located between the first PHY and the second PHY for transferring data and control signals with the first and the second PHYs to avoid the data collision occurred between the first and the second conversion controller through the pair of signal lines.

2. The Ethernet system as recited in claim 1, wherein the MIIC sets the AN state, the data transmission speed, the duplex mode of the first PHY to have an AN activation, 10 Mbps or 100 Mbps, and a half duplex mode and a link pass mode, respectively; and
wherein the MIIC sets the AN state, the data transmission speed, the duplex mode of the second PHY to set an AN inactivation state, 10 Mbps or 100 Mbps, a full duplex mode and a link pass mode, respectively.

3. The Ethernet system as recited in claim 2, wherein the MIIC prevents the data from any one selected from the first PHYs from being transmitted to its counterpart first PHY by establishing the counterpart PHY to be set as a half duplex mode so that the data collision is avoided during the selected first PHY is receiving data from the counterpart first PHY while the selected first PHY is transmitting the counterpart first PHY through the pair of the signal lines.

4. The Ethernet system as recited in claim 1, wherein the conversion control logic ignores the data being looped back while any one selected from the second PHYs sends the data to its counterpart PHY, thereby preventing the data collision due to the loop-back.

5. The Ethernet system as recited in claim 4, wherein the conversion control logic includes memory, the memory storing the data from the second PHY and transmitting the stored data to the first PHY when there occurs data collision, to thereby minimize the speed of transmission.

6. The Ethernet system as recited in any one of proceeding claims 1 to 4, wherein the first or the second conversion controller is replaced with an analog conversion controller including a transmission data detector for detecting data to be transmitted from the link partner, a transmission amplifier for amplifying the transmission data, a receiving amplifier for amplifying data to be received from the link partner, and a receiving detector for detecting the output of the receiving amplifier,
wherein the receiving amplifier is made in an OFF state by the transmission data detector when it detects the transmission data and the transmission amplifier is made in an OFF state by the receiving data detector when it detects the receiving data.

7. The Ethernet system as recited in any one of proceeding claims 1 to 4, wherein the MIIC further includes a memory for buffering the data transferred between the first and the second PHYs in a scheme using different frequencies in which the data communication between the LAN card and the first conversion controller, the data communication between the first conversion controller and the second conversion controller and the data communication between the second conversion controller and the switching hub.

8. An Ethernet system for performing data communications between a LAN card and a switching hub, each of which has a Physical Layer Interface (PHY) and has the relationship of link partners, which comprises:
a first and a second conversion controllers located between the LAN card and the switching hub for intermediating the data communications with their respective corresponding link partners; and
a pair of signal lines for connecting the first and the second conversion controllers,
wherein the first and the second conversion controllers are regarded as sub-link partners of their respective corresponding link partner, and each of the first and the second conversion controller includes:
a first PHY and a second PHY, wherein the first PHY is connected to its corresponding link partner through an unshielded twisted pair (UTP) cable and the second PHYs contains two output terminals TX+ and TX− and two input terminals RX+ and RX−, for interfacing with its sub-link partner, wherein the output terminal TX+ and the input terminal RX+ are tied to one of the signal lines and the output terminal TX− and the input terminal RX− are connected to the other of the signal lines, and wherein each of the first and the second PHYs has a basic register and auxiliary register for storing particular values;
a Media Independent Interface Controller(MIIC) located between the first PHY and the second PHY for establishing a link mode, a data transmission speed, a duplex mode and an auto-negotiation (AN) state to be stored in the first and the second PHYs; and
a conversion control logic located between the first PHY and the second PHY for preventing the data transmitted from one of the second PHYs to the other second PHY from being looped back to the one of the second PHY.

9. The Ethernet system as recited in claim 8, wherein the MIIC establishes the basic register in the first PHY to set an AN inactivation state, a data transmission speed of 10 Mbps or 100 Mbps and a full duplex mode and establishes the auxiliary register in the first PHY to set a link pass mode, respectively; and
wherein the MIIC establishes the basic register in the second PHY to set an auto-negotiation (AN) activation state and a data transmission speed of 10 Mbps or 100 Mbps and the auxiliary register in the second PHY to set a link pass mode, respectively.

10. The Ethernet system as recited in claim 9, wherein the MIIC prevents the data from any one selected from the first PHYs from being transmitted to its counterpart first PHY by establishing the counterpart PHY to be set as a half duplex mode so that the data collision is avoided during the selected first PHY is receiving data from the counterpart first PHY while the selected first PHY is transmitting the counterpart first PHY through the pair of the signal lines.

11. The Ethernet system as recited in claim 10, wherein the conversion control logic ignores the data being looped back while any one selected from the second PHYs sends the data to its counterpart PHY, thereby preventing the data collision due to the loop-back.

12. The Ethernet system as recited in any one of proceeding claims 8 to 11, wherein the MIIC further includes a memory for buffering the data transferred between the first and the second PHYs in a scheme using different frequencies in which the data communication between the LAN card and the first conversion controller, the data communication between the first conversion controller and the second conversion controller and the data communication between the second conversion controller and the switching hub.
